(19) United States
(12) Patent Application Publication
(10) Pub. No.: US 2003/0121032 A1
(43) Pub. Date: Jun. 26, 2003

(54) Method and system for remotely updating function of household device

(75) Inventors: Song-Yean Cho, Seoul (KR); Dae-Young Seo, Seoul (KR); Woon-Jae Chung, Gunpo-si (KR); Kyoung-Hoon Yi, Seoul (KR); Yeon-Ho Jin, Goyang-si (KR)

Correspondence Address: SUGHRUE MION, PLLC, 2100 PENNSYLVANIA AVENUE, N.W., WASHINGTON, DC, 20037, US

(73) Assignee: SAMSUNG ELECTRONICS CO., LTD.

(21) Appl. No.: 10/320,632

(22) Filed: Dec. 17, 2002

(30) Foreign Application Priority Data
Dec. 21, 2001 (KR) 2001-82491

(51) Int. Cl. G06F 9/445; G06F 9/44

(52) U.S. Cl. 717/173; 717/178

(57) ABSTRACT

Provided are method and system for remotely updating a household device. The household device, which is coupled to a predetermined server through a communication network and can be remotely updated with update function data downloaded from the server, includes a first unit that forcibly converts the household device into a download mode when the household device is in a state in which it cannot automatically or manually receive the update function data; and a second unit that receives the update function data from the server according to the authorization of the first unit and updates a system function. Accordingly, the external update function data can be downloaded to the household device through the network to update the function of the household device without expense of human resources, even if the household device operates abnormally.

### BACKGROUND OF THE INVENTION

1. Field of the Invention

The present invention relates to a method and system of updating a function of a household device on a home network, and more particularly, to a method and system for remotely updating a function of a household device after converting the household device into an update mode without requiring a user to manually operate the process.

The present application is based on Korean Patent Application No. 2001-82491, filed Dec. 21, 2001, which is incorporated herein by reference.

2. Description of the Related Art

With the recent development of home networking technology, related art techniques of remotely updating the functions of devices connected to a home network have been being proposed.

FIG. 1 is a diagram of a related art system for remotely updating household devices connected to a home network. The system shown in FIG. 1 has a structure in which a system function download server 100 is connected to a home network system 110 through the Internet 120.

The system function download server 100 includes a storage unit 101 which stores an “update function” for updating a function of a household device 111 on the home network.

The home network system 110 includes a home gateway 112 that relays information between each of the household devices 111, which are connected to one another through a related art bus having a predetermined standard, and an external communication network, such as the Internet 120.

FIG. 2 is a flowchart of a remote update performed by a related art system as described above. FIG. 2 shows how a remote update is performed in accordance with the relationship among the system function download server 100, the home gateway 112, and a single household device 111 shown in FIG. 1.

In FIG. 2, a user determines that it is necessary to update a household device and manually converts the household device to a system update mode using a particular interface specification provided from the household device in step (1). Similar to changing the BIOS setup on a computer, the user can convert the household device to a system update mode by inputting a special key related to a system update when booting the household device. When the household device is in a state in which content can be downloaded to the household device due to a conversion in step (2), the user designates and inputs a function to be updated and the address of a server from which update function data (which may be referred to as a system image) corresponding to the function is to be downloaded by using a particular interface function of the household device in step (3).

Next, the household device 111 accesses the server 100 having the address which was input by the user, through the home gateway 112 and the Internet 120 in step (4). The household device 111 requests the update function data designated by the user from the server 100 in step (5). The server 100 transmits the update function data requested by the household device 111 to the household device 111 in step (6). Upon receiving the update function data from the server 100, the household device 111 stores the update function data in a system start area, such as ROM BIOS, and updates the function by re-booting in step (7).

In the structure and operation of the above-described related art system updating, a user must perform particular acts when upgrading or updating the system of the household device although update function data is downloaded from a remote server to a household device. For example, as shown in FIG. 2, the user needs to input a special key to convert the household device to an update mode, and after the conversion of the household device, the user needs to input a function to be updated and the address of a server from which update function data corresponding to the input function is to be downloaded.

However, the aforementioned related art system has various problems and disadvantages. For example, but not by way of limitation, the aforementioned related art system and method for remotely updating a household device requires people to know and understand an update process thoroughly. In particular, the conversion of a household device to an update mode, in which the household device can receive update function data, must be performed manually according to related art technology.

Additionally, even if a household device can be automatically converted into an update mode by executing predetermined software installed in the household device, the software cannot be driven properly when the system operates abnormally.

### SUMMARY OF THE INVENTION

To solve the above-described problems, it is an object of the present invention to provide a system and method for remotely updating a function of a household device through which update function data can be externally downloaded to the household device through a network without the necessity of a user to manually operate the process even if the household device operates abnormally.

It is also an object of the present invention to overcome at least the problems and disadvantages of the aforementioned related art system and method.

To achieve the above object of the present invention, there is provided a household device, which is connected to a predetermined server through a communication network and can be remotely updated with update function data downloaded from the server. The household device includes a first unit which forcibly converts the household device into a download mode when the household device is in a state in which it cannot automatically or manually receive the update function data; and a second unit which receives the update function data from the server according to the authorization of the first unit and updates a system function.

Preferably, the first unit is a network interface card.

Preferably, the second unit includes a first memory, which stores function data or a program to be executed; a second memory, which stores a download/setup program; and a second processor, which executes the programs stored in the first and second memories.

Preferably, the first unit includes a first processor that analyzes an external download command for downloading the update function data, generates an interrupt signal, and outputs the interrupt signal to the second processor.

Preferably, the second processor of the second unit stops a program under execution and executes the download/setup program stored in the second memory when it receives the interrupt signal from the first processor.

Preferably, the download/setup program is executed to access a gateway, receive the update function data from the server, and overwrite the function data of the first memory with the update function data.

Preferably, the download command is transmitted to the second unit from a gateway, which is connected to the household device through a home network and allows the household device to access the server.

Preferably, the first memory of the second unit includes a download agent, which detects an address of a download manager and stores the address.

Preferably, the download agent accesses the download manager of the gateway to provide household device information to the download manager.

Preferably, the gateway searches the server including the update function data for the household device based on the household device information, provides the household device information to the server, and registers the household device information in the server.

There is also provided a system for remotely updating a household device with update function data provided from a server. The system includes a household device, which receives the update function data from the server to update an existing function; and a gateway, which relays communication between the server and the household device and forcibly converts the household device into a download mode.

Preferably, the household device includes a first unit, which forcibly converts the household device into the download mode according to a command of the gateway when the household device is in a state in which it cannot automatically or manually receive the update function data; and a second unit, which receives the update function data from the server via the gateway according to the authorization of the first unit and updates a system function.

Preferably, the first unit is a network interface card.

Preferably, the second unit includes a first memory, which stores function data or program to be executed; a second memory, which stores a download/setup program; and a second processor, which executes the programs stored in the first and second memories.

Preferably, the first unit includes a first processor, which forcibly executes a program stored in the second memory of the second unit in response to a download command, for downloading the update function data, received from the gateway.

Preferably, the gateway includes a download manager, which relays communication between the household device and the server to allow data to be downloaded from the server to the household device, and the first memory of the second unit includes a download agent, which detects an address of the download manager and stores the address.

Preferably, the download agent accesses the download manager of the gateway to provide household device information to the download manager.

Preferably, the download manager transmits a predetermined data packet for forcibly converting the household device into the download mode to the household device when the household device cannot convert to the download mode by itself.

Preferably, the first unit of the household device checks the predetermined data packet, and the first processor generates an interrupt signal.

Preferably, the second processor of the second unit stops the function program under execution, which is stored in the first memory, in response to the interrupt signal from the first processor of the first unit and executes the download/setup program stored in the second memory.

Preferably, the download/setup program includes accessing the download manager of the gateway and receiving the update function data, which has been transmitted from the server, from the download manager.

There is also provided a method performed by a household device for updating its function with update function data, which is downloaded from a remote server to the household device through a relay of a gateway. The method includes receiving a command to convert into a download mode from the gateway; stopping a current operation and receiving the update function data from the remote server through the gateway in response to the command; and restarting an operation through rebooting and executing an update function.

Preferably, the step of receiving the command includes receiving a data packet having a particular format from the gateway, when the household device has an error in its download program.

Preferably, the data packet is processed by the household device that performs the steps of: checking the data packet using a first processor included in a network card within the household device; generating an interrupt signal for a second processor, which supervises a function program of the household device, when the data packet indicates conversion into a download mode; and stopping the function program under execution and executing a download/setup program using the second processor.

Preferably, the download/setup program includes accessing the gateway: receiving the update function data that is transmitted from the server to the gateway and updating an existing function; and rebooting the household device.

Additionally, a household device, coupled to a server through a communication network and configured to be remotely updated with update function data downloaded from the server, is provided. The household device includes a first unit that forcibly converts the household device into a download mode when the household device cannot automatically or manually receive the update function data, and a second unit which receives the update function data from the server according to an authorization of the first unit, and updates a system function.

Also, a system for remotely updating a household device with update function data provided from a server is provided. The system comprises a household device, which receives the update function data from the server to update an existing function, and a gateway, which relays communication between the server and the household device, and forcibly converts the household device into a download mode.

Further, a method performed for updating a function of a household device with update function data, which is downloaded from a server to the household device through a relay of a gateway, is provided. The method includes the steps of receiving a command to convert into a download mode from the gateway, stopping a current operation and receiving the update function data from the server through the gateway in response to the command, and restarting an operation by rebooting and executing an update function.

In addition, a gateway, which relays communication between a household device and a server, the gateway being coupled to the household device through a home network and being coupled to the server through a predetermined communication network, is provided. The gateway includes a first storage unit, which stores household device information about the household device, a second storage unit, which stores server information about the server, and a download manager, which provides the household device information to the server and provides an update command and update function data received from the server to the household device when the update command for the household device is received from the server. The household device does not convert to an update mode by itself, and the download manager transmits a packet having a predetermined format to the household device to forcibly convert the household device to the update mode.

### BRIEF DESCRIPTION OF THE DRAWINGS

The above object and advantages of the present invention will become more apparent by describing in detail preferred embodiments thereof with reference to the attached drawings in which:

FIG. 1 is a diagram of a related art system for remotely updating household devices connected to a home network;

FIG. 2 is a flowchart of a remote update performed by a related art system as described above;

FIG. 3 is a schematic diagram of a system for remotely updating a function of a household device according to an embodiment of the present invention;

FIG. 4 is a flowchart of a procedure of remotely registering household device information in a management server in a method of remotely updating a function of a household device according to an embodiment of the present invention;

FIG. 5 is a flowchart of a procedure of updating the version of a household device for which registration has been completed by the procedure shown in FIG. 4;

FIG. 6 is a flowchart of a procedure of processing a magic packet; and

FIG. 7 is a detailed flowchart of the procedure of executing a download/setup program shown in FIG. 6.

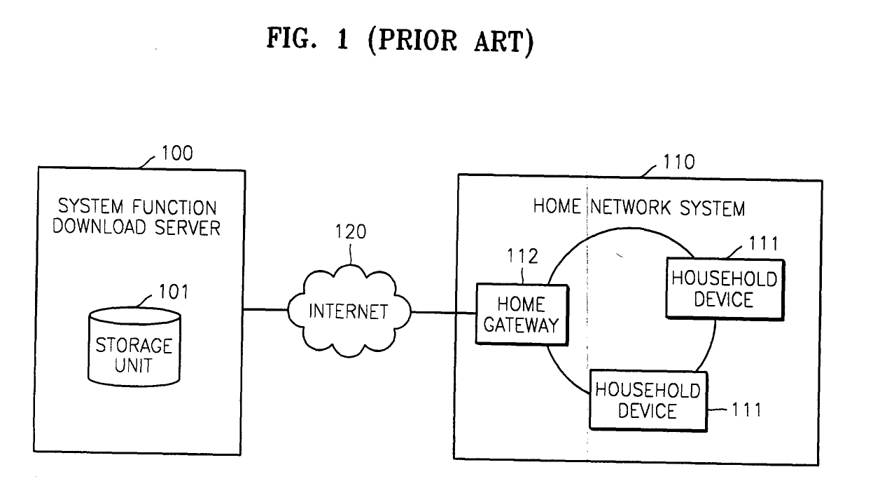

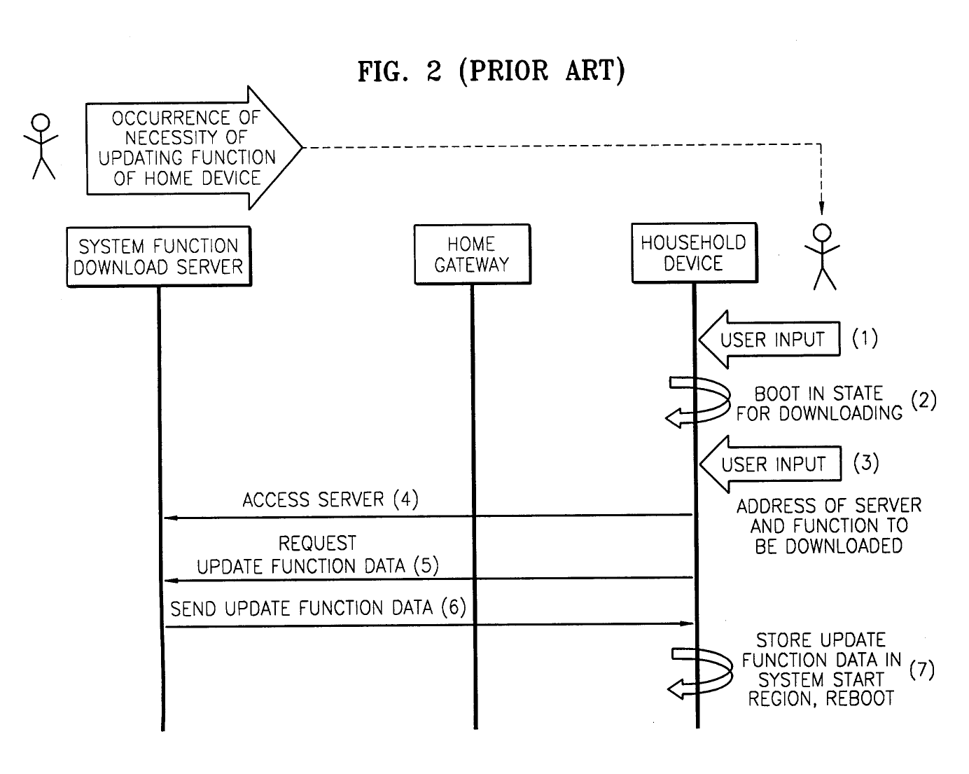

### DETAILED DESCRIPTION OF THE INVENTION

Reference will now be made in detail to the preferred embodiment of the present invention, examples of which are illustrated in the accompanying drawings. In the present invention, the terms are meant to have the definition provided in the specification, and are not otherwise limited by the specification.

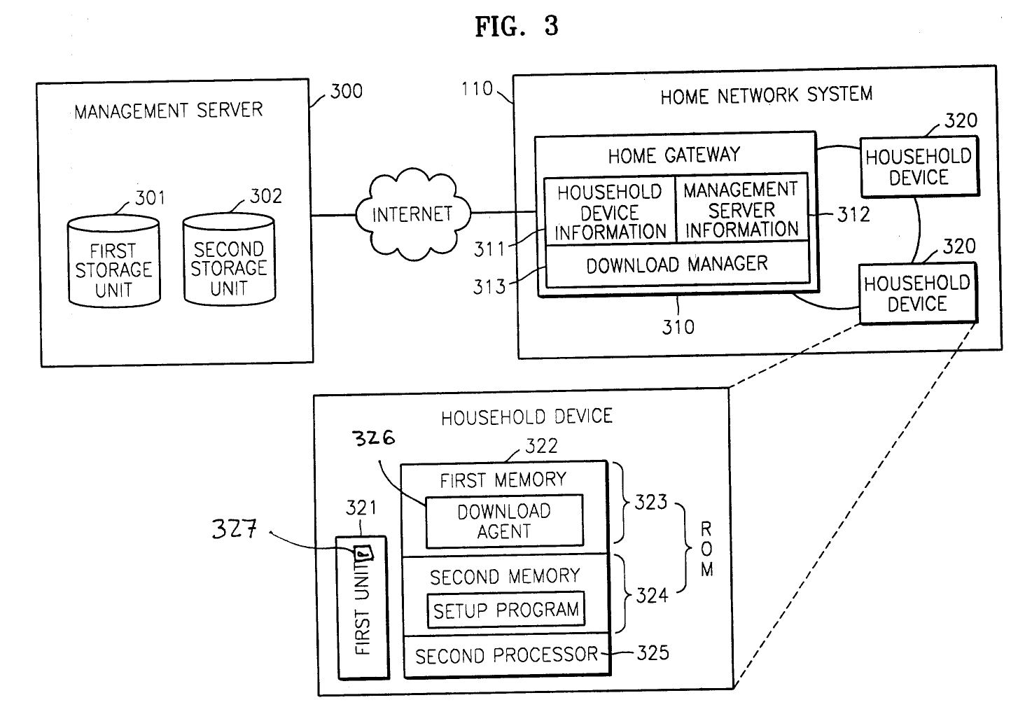

FIG. 3 illustrates a non-limiting, exemplary embodiment of a system for remotely updating a function of a household device, including a management server 300, a gateway 310, and one or more household devices 320.

The management server 300 includes a first storage unit 301, which stores information about the household devices 320, and a second storage unit 302, which stores update function data that is added to or modifies the functions of the household devices 320. The household device information stored in the first storage unit 301 can be uploaded through the Internet. The household device information may include (but is not limited to) a maker, a product number, and a gateway address, such as an internet protocol (IP) address or a uniform resource locator (URL), of a network including a household device, etc.

The update function data stored in the second storage unit 302 may be provided by a maker of a household device so that the household device can be updated with an improved function through the maker's server. Here, the “function” and “update function” of a household device are stored in ROM BIOS therewithin, in the form of program data so that the function can be performed in the household device. The management server 300 searches the first storage unit 301 for a household device 320 that needs to be updated with update function data stored in the second storage unit 302, and accordingly transmits an update command and the update function data to the household device 320.

The gateway 310 is connected to the household devices 320 through, for example (but not by way of limitation), a home network, and relays communication between each household device 320 and the management server 300. The gateway 310 stores the addresses of and information about the household devices 320 on the home network. In addition, the gateway 310 may store the address of the management server 300 related to the household devices 320 and information about the management server 300. If each of the household devices 320 is initially installed onto the home network, the gateway 310 transmits information about each household device 320 to the related management server 300 and registers the information in the management server 300.

The management server 300 can transmit an update command to the gateway 310 according to the registered household device information. If the gateway 310 receives an update command regarding a particular household device 320 from the management server 300, it transmits the update command to the particular household device 320. If the gateway 310 confirms an abnormality in the update or download state of the household device 320, such as not answering the update command, the gateway 310 generates a signal (hereinafter referred to as a magic packet) to forcibly convert the household device 320 into a state in which an update or download can be performed.

The gateway 310 includes a portion 311 for storing information about the household devices 320 coupled to the home network, a portion 312 for storing information about the management server 300 having information on the household devices 320, and a download manager 313 for relaying various operations regarding update function download between each of the household devices 320 and the management server 300 having information on the household devices 320. Preferably, the gateway 310 searches for the management server 300 that includes update function data for a household device 320, based on the household device information received from the household devices 320 and registers the household device information in the searched management server 300.

Each of the household devices 320 includes a first unit 321, which is coupled to the home network to communicate with the gateway 310, and a second unit 322, which performs a predetermined function of a relevant household device 320. The first unit 321 can also forcibly convert the household device 320 into a normal download mode when update function data cannot be automatically or manually downloaded to the household device 320.

When a download program in the second unit 322 is not executed normally, the download program is forcibly executed by the first unit 321 so that the existing function can be updated with the downloaded update function data. The first unit 321 may be a network interface card usually having a processor that enables communication, but it is not limited thereto. The second unit 322 includes a first memory 323 for storing function data or program to be executed, a second memory 324 for storing a download/setup program, and a processor 325 for executing the program stored in the first and second memories 323 and 324. For clarity of the description, a processor 327 included in the first unit 321 is referred to as a first processor, and the processor 325 included in the second unit 322 is referred to as a second processor.

Upon receiving a magic packet from the download manager 313 of the gateway 310, the first processor 327 of the first unit 321 generates and transmits an interrupt signal to the second processor 325 of the second unit 322.

If the second processor 325 receives the interrupt signal from the first processor 327 in the first unit 321 while executing the function program stored in the first memory 323, it stops executing the function program and starts the download/setup program stored in the second memory 324. When the download/setup program is executed, the household device 320 accesses the gateway 310, receives update function data transmitted from the management server 300, and updates the first memory 323 with the update function data.

The first memory 323 includes a download agent 326, which detects and stores the address of the download manager 313 of the gateway 310. When the household device 320 is booted or receives a manual or automatic download or update command, the download agent 326 is read from the first memory 323. The read download agent 326 can access the download manager 313 of the gateway 310 using the address, and can provide relevant household device information for registration to the download manager 313, or can receive the update function data (or program) downloaded from the gateway 310. When the download agent 326 does not operate normally, the first unit 321 generates the interrupt signal based on the magic packet received from the gateway 310. Then, the second processor 325 of the second unit 322 transfers a program execution address such as a stack pointer (SP) to the second memory 324 in response to the interrupt signal from the first unit 321, so that the download/setup program can be executed.

The following description concerns a method of remotely updating a function of a household device, which is performed by the system shown in FIG. 3.

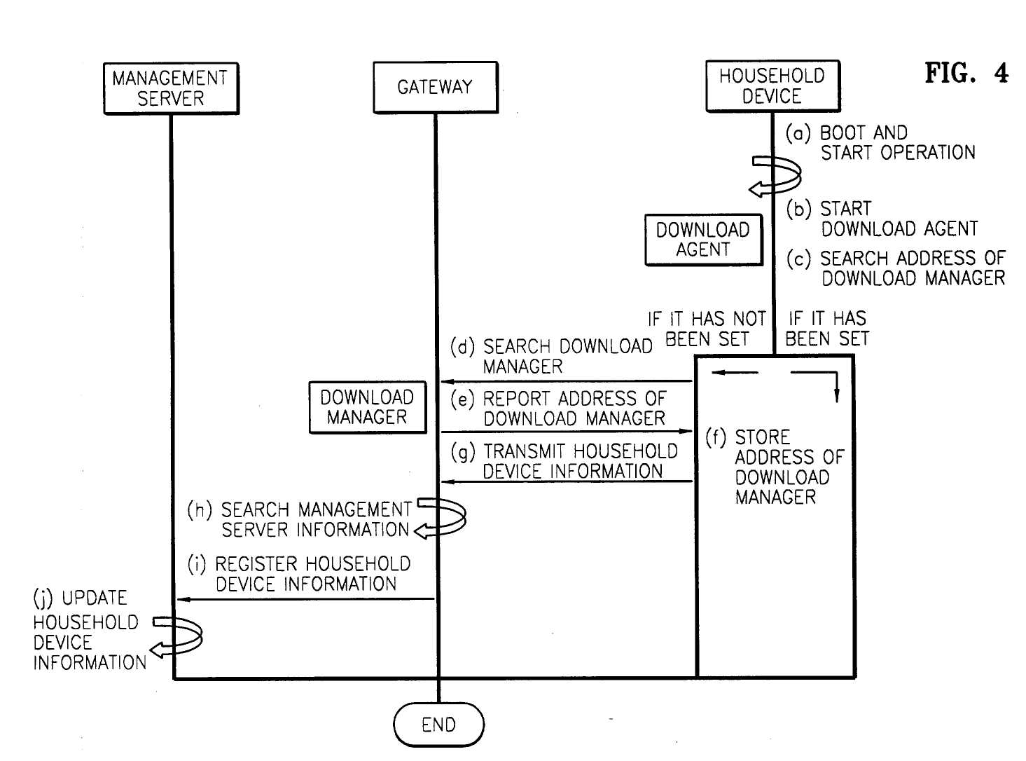

FIG. 4 is a flowchart illustrating a procedure of remotely registering household device information in a management server, which is part of the method of remotely updating a function of a household device according to an embodiment of the present invention. FIG. 4 shows the flow of signals among relevant elements.

In step (a), the household device 320 is booted and starts to operate. The download agent 326 within the household device 320 is driven in step (b), and searches for the address of the download manager 313 of the gateway 310 in step (c). Here, if the address of the download manager 313 has been set, it is considered that household device information was registered in the management server 300 previously, and the procedure ends.

However, if the address of the download manager 313 has not been set, a signal for searching the download manager 313 is transmitted to the gateway 310 in step (d). Then, the address of the download manager 313 is reported from the gateway 310 in step (e). The household device 320 stores the address of the download manager 313 in step (f). In this situation, the address of the download manager 313 must be stored in nonvolatile memory only. In step (g), the household device 320 transmits the household device information including maker name, system version, product number, and model name to the gateway 310. The gateway 310 stores the received household device information, then searches for the management server 300 corresponding to the household device information in step (h), and subsequently transmits the household device information to the searched management server 300 in step (i). The management server 300 updates existing household device information and stores the updated household device information in step (j).

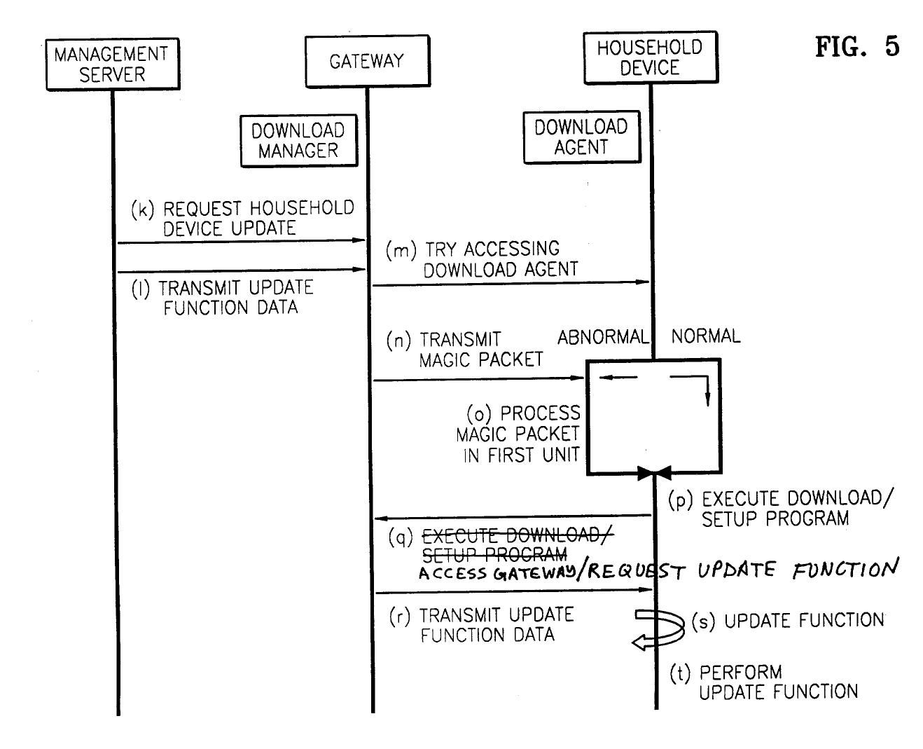

FIG. 5 is a flowchart illustrating a procedure of updating the version of the household device 320, for which the registration of information in the management server 300 has been completed by the procedure shown in FIG. 4. FIG. 5 also shows the flow of sequential signals generated from relevant elements.

In step (k), the management server 300 determines whether the household device 320 needs a version update based on the household device information that it holds, and transmits a signal requesting a household device update to the gateway 310 that is on a network containing the household device 320 needing a version update. The management server 300 also transmits update function data (i.e., upversion function data) for the household device 320 to the gateway 310 in step (1).

The gateway 310 attempts to access the download agent 326 of the household device 320 using the download manager 313 in step (m). If the access attempt is not successful, the gateway 310 transmits a magic packet to the household device 320 in step (n). The magic packet is a data packet having a predetermined format and is designed to make the first unit 321 of the household device 320 recognize a forcible download command.

After checking the magic packet, the household device 320 generates an interrupt signal using the first processor 327 of the first unit 321 to stop the current operation of the household device 320 in step (o). However, if the operation is proceeding normally, step (c) is skipped. After stopping the current operation, the household device 320 executes the download/setup program stored in the second memory 324 of the second unit 322 in step (p). Upon the execution of the download/setup program, the household device 320 accesses the gateway 310 and requests the update function data in step (q). The address of the download manager 313 stored in the procedure shown in FIG. 4 is searched and used to access to the gateway 310. The download manager 313 of the gateway 310 transmits the update function data to the household device 320 in step (r). The household device 320 updates an existing function with the received update function data in step (s). Here, an existing function program stored in the first memory 323 is overwritten by the new update function data (or program). After updating the function program, the household device 320 is restarted, for example, rebooted, and then performs a new updated function in step (t).

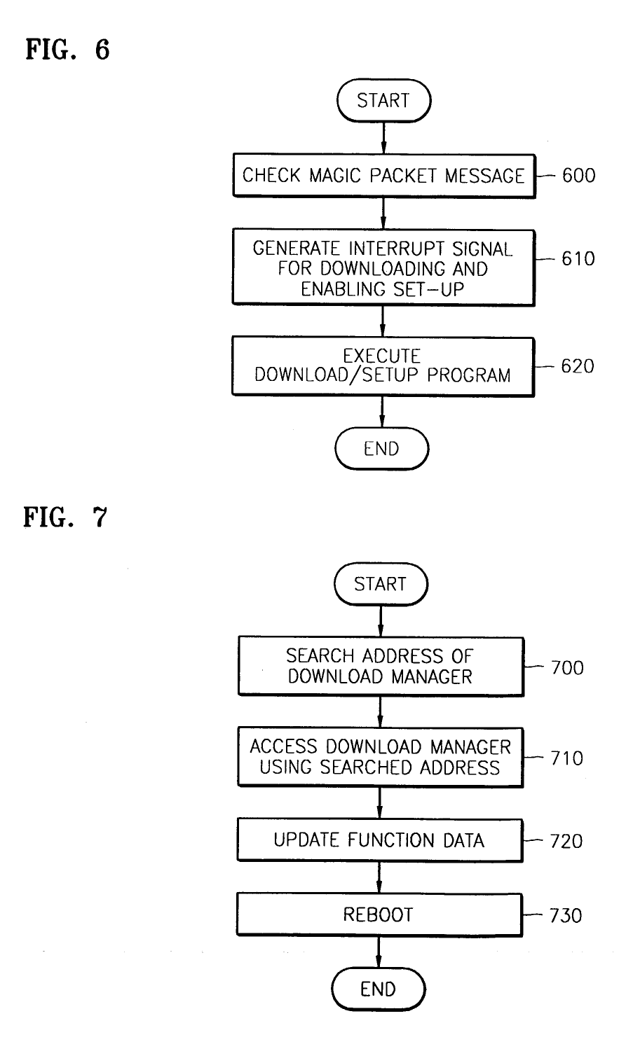

FIG. 6 is a flowchart illustrating a procedure of processing a magic packet. The first unit 321 of the household device 320 checks a magic packet transmitted from the gateway 310 to determine whether the magic packet includes an update command message in step 600. If the magic packet is confirmed to include an update command message, the first processor 327 of the first unit 321 generates an interrupt signal for the second processor 325 of the second unit 322 in step 610. The second processor 325 of the second unit 322 stops a currently executed program stored in the first memory 323 and executes the download/setup program stored in the second memory 324 in step 620.

FIG. 7 is a detailed flowchart of the procedure of executing the download/setup program shown in FIG. 6. The household device 320 searches for the address of the download manager 313 of the gateway 310 in step 700. Then, the household device 320 accesses the download manager 313 using the searched address in step 710, receives update function data (or program), which is downloaded from the management server 300 to the gateway 310, and overwrites a function program, which has been stored in the first memory 323, with the update function data in step 720. Then, the household device 320 reboots and executes an updated function in step 730.

The above-described embodiments have various advantages. For example, but not by way of limitation, as described above, the present invention can remove all of the operations performed by a user when updating a household device, thereby reducing the expenses incurred for human resources needed to update household devices with new functions. Particularly, when a household device cannot perform necessary operations for a function update in an abnormal state, the present invention can forcibly convert the household device into a state allowing an update by using a built-in device, such as a network interface card within the household device.

According to the present invention, external update function data can be downloaded to a household device through a network to update a function of the household device, without the expense of human resources, even if the household device operates abnormally.

Although the preferred embodiment of the present invention has been described, it will be understood by those skilled in the art that the present invention should not be limited to the described preferred embodiment, but various changes and modifications can be made within the spirit and the scope of the present invention. Accordingly, the scope of the present invention is not limited to the described range of the following claims.

What is claimed is:

1. A household device, coupled to a server through a communication network and configured to be remotely updated with update function data downloaded from the server, comprising:
a first unit that forcibly converts the household device into a download mode when the household device cannot automatically or manually receive the update function data; and
a second unit which receives the update function data from the server according to an authorization of the first unit, and updates a system function.

2. The household device of claim 1, wherein the first unit is a network interface card.

3. The household device of claim 1, wherein the second unit comprises:
a first memory, which stores function data or a program to be executed;
a second memory, which stores a download/setup program; and
a second processor, which executes the function data or the program and the download/setup program stored in the first memory and the second memory, respectively.

4. The household device of claim 2, wherein the first unit comprises a first processor that analyzes an external download command for downloading the update function data, generates an interrupt signal, and outputs the interrupt signal to the second processor.

5. The household device of claim 4, wherein the second processor stops a program under execution and executes the download/setup program stored in the second memory when said second processor receives the interrupt signal from the first processor.

6. The household device of claim 5, wherein the download/setup program is executed to access a gateway, receive the update function data from the server, and overwrite the function data of the first memory with the received update function data.

7. The household device of claim 4, wherein the external download command is transmitted to the second unit from a gateway, coupled to the household device through a home network, and said gateway allows the household device to access the server.

8. The household device of claim 4, wherein the first memory comprises a download agent that detects an address of a download manager and stores the address.

9. The household device of claim 8, wherein the download agent accesses the download manager of a gateway to provide household device information to the download manager.

10. The household device of claim 9, wherein the gateway searches the server, including the update function data, for the household device based on the household device information, provides the household device information to the server, and registers the household device information in the server.

11. A system for remotely updating a household device with update function data provided from a server, the system comprising:
a household device, which receives the update function data from the server to update an existing function; and
a gateway, which relays communication between the server and the household device, and forcibly converts the household device into a download mode.

12. The system of claim 11, wherein the household device comprises:
a first unit, which forcibly converts the household device into the download mode according to a command of the gateway when the household device cannot automatically or manually receive the update function data; and
a second unit, which receives the update function data from the server via the gateway according to the authorization of the first unit and updates a system function.

13. The system of claim 12, wherein the first unit is a network interface card.

14. The system of claim 12, wherein the second unit comprises:
a first memory, which stores function data or program to be executed;
a second memory, which stores a download/setup program; and
a second processor, which executes the programs stored in the first and second memories.

15. The system of claim 13, wherein the first unit comprises a first processor, which forcibly executes a program stored in the second memory of the second unit in response to a download command, for downloading the update function data, received from the gateway.

16. The system of claim 14, wherein the gateway comprises a download manager, which relays communication between the household device and the server to allow data to be downloaded from the server to the household device, and the first memory comprises a download agent, which detects an address of the download manager and stores the address.

17. The system of claim 16, wherein the download agent accesses the download manager of the gateway to provide household device information to the download manager.

18. The system of claim 16, wherein the download manager transmits a predetermined data packet for forcibly converting the household device into the download mode to the household device when the household device cannot convert to the download mode by itself.

19. The system of claim 15, wherein the first unit of the household device checks the predetermined data packet, and the first processor generates an interrupt signal.

20. The system of claim 19, wherein the second processor stops the function program under execution, which is stored in the first memory, in response to the interrupt signal from the first processor and executes the download/setup program stored in the second memory.

21. The system of claim 20, wherein the download/setup program comprises accessing the download manager of the gateway and receiving the update function data, which has been transmitted from the server, from the download manager.

22. A method performed for updating a function of a household device with update function data, which is downloaded from a server to the household device through a relay of a gateway, the method comprising:
receiving a command to convert into a download mode from the gateway;
stopping a current operation and receiving the update function data from the server through the gateway in response to the command; and
restarting an operation by rebooting and executing an update function.

23. The method of claim 22, wherein the step of receiving the command comprises receiving a data packet having a particular format from the gateway, when the household device has an error in its download program.

24. The method of claim 23, wherein the data packet is processed by the household device that performs the steps of:
checking the data packet using a first processor included in a network card within the household device;
generating an interrupt signal for a second processor, which supervises a function program of the household device, when the data packet indicates conversion into a download mode; and
stopping the function program under execution and executing a download/setup program using the second processor.

25. The method of claim 24, wherein the download/setup program performs the steps comprising:
accessing the gateway:
receiving the update function data that is transmitted from the server to the gateway and updating an existing function; and
rebooting the household device.

26. A gateway, which relays communication between a household device and a server, the gateway being coupled to the household device through a home network and being coupled to the server through a predetermined communication network, the gateway comprising:
a first storage unit, which stores household device information about the household device;
a second storage unit, which stores server information about the server; and
a download manager, which provides the household device information to the server and provides an update command and update function data received from the server to the household device when the update command for the household device is received from the server,
wherein when the household device does not convert to an update mode by itself, and the download manager transmits a packet having a predetermined format to the household device to forcibly convert the household device to the update mode.

27. The household device of claim 3, wherein the first unit comprises a first processor that analyzes an external download command for downloading the update function data, generates an interrupt signal, and outputs the interrupt signal to the second processor.

28. The system of claim 14, wherein the first unit comprises a first processor, which forcibly executes a program stored in the second memory of the second unit in response to a download command, for downloading the update function data, received from the gateway.

29. The system of claim 18, wherein the first unit of the household device checks the predetermined data packet, and the first processor generates an interrupt signal.
